(19) United States
(12) Patent Application Publication
(10) Pub. No.: US 2004/0125419 A1
(43) Pub. Date: Jul. 1, 2004

(54) [SCANNER AND ASSOCIATED SCANNING HEAD DESIGN]

(76) Inventors: CHUAN-YU HSU, HSINCHU (TW); JEN-SHOU TSENG, MIAO-LI HSIEN (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,172

(22) Filed: Jun. 30, 2003

(30) Foreign Application Priority Data
Dec. 30, 2002 (TW) 91137814

(51) Int. Cl. H04N 1/04; H04N 1/46

(52) U.S. Cl. 358/497; 358/509

(57) ABSTRACT

A scanner that includes an outer casing, a platform, a scanning head, a driving device and a linear guide is provided. The scanning head further comprises a shell body, a scattering light source, a set of reflecting mirrors, a lens and a photo-sensor. The scanning head is able to move forward in a scanning direction. The shell body has a long side whose length is smaller than the length of the platform in a direction perpendicular to the scanning direction. Furthermore, the scattering light source has a length smaller than or equal to the length of the long side. With this design, a miniaturized and lighter scanning head is produced so that some material is saved and yet length of the scanning line for scanning a document and size of the platform remain unaffected. Additionally, platform area is fully utilized.

### CROSS REFERENCE TO RELATED APPLICATIONS

This application claims the priority benefit of Taiwan application serial no.91137814, filed on Dec. 30, 2002.

### BACKGROUND OF INVENTION

1. Field of Invention

The present invention relates to a scanner and an associated scanning head design. More particularly, the present invention relates to a method of designing a lightweight and miniaturized scanning head.

2. Description of Related Art

Due to the rapid progress in electronic know-how, consumer electronic products are operating faster and are functionally more powerful. Demands for portability and handiness have also pushed the designs of electronic products towards smaller size, slimmer structure and lighter overall weight. This trend is also applicable to the development of scanners. At present, the most common flatbed scanners have a flatbed and a chassis. For a scanner designed to accommodate an A4 size paper, the flatbed window must have a width comparable to an A4 size paper. In addition, length of the scanning head must correspond to the size of the scanning platform. Moreover, the interior of the scanner must have sufficient space to permit the scanning head to move across a scan document.

In general, the structure of an image scanner must incorporate design concepts including volume occupation of the scanning head, type of lamp, overall length of the lamp and so on. Hence, any breakthrough in design is likely to lead to a drop in the production cost or an increase in profit. However, material cost is one of the principal determinants in overall production cost of the scanner.

FIG. 1 is a side view of a conventional scanner. As shown in FIG. 1, the design of most scanners 100 has an opening section 104 on an outer casing 102. The opening 104 is a rectangular opening having area capable of accommodating an A4 size paper, for example. A scanning platform 106 is positioned over the opening section 104. The scanning platform 106 is attached to the interior sidewalls of the outer casing 102 using, for example, double-sided adhesive tape (not shown). The scanning platform 106 can have a dimension (or area) larger than the dimension (or area) of the opening section 104 to facilitate the attachment of the outer edges of the scanning platform 106 to the interior sidewalls of the outer casing 102. Thus, the scanning platform 106 forms a transparent window with a size comparable to the opening section 104 for putting a scan document 108. In addition, a scanning head 110 is housed inside the outer casing 102. Through a lamp 112 projecting a parallel beam of light 113 to a document 108 on the scanning platform 106, an image of the document 108 can be captured by the scanner.

FIG. 2 is a schematic diagram showing the optical path design of a conventional scanning head. As shown in FIG. 2, the scanning head 110 includes a group of optical image-forming system having a lamp 112, a plurality of reflective mirrors 114, a lens 116 and a photo-sensor 118. The lamp 112 is mounted on a shell casing 111. The reflective mirrors 114, the lens 116 and the photo-sensor 118 are sequentially arranged within the shell casing 111. The parallel beams of light 113 produced by the lamp 112 are projected onto the scanning platform 106. Light images reflected from the document 108 (or a transparent document) pass through the first, the second and the third reflecting mirrors 114 sequentially to form a light cone that focuses on the lens 116. Thereafter, images of the document 108 pass through the lens 116 and project onto the photo-sensor 118.

Note that dimensions of the shell casing 111 are often reduced to lower material cost. With a smaller shell casing 111, the optical image system must be designed within the reduced area. If lengths of the lamp 112 and the reflecting mirrors 114 somehow could not be reduced, length of the shell casing 111 must remain. In other words, there is no way to miniaturize the scanning system. However, length of the lamp 112 and the reflecting mirrors 114 are designed according to size of the scanning window (maximum size of scan document) on the scanning platform 106. Thus, length of the lamp 112 cannot be reduced. Otherwise, the lamp 112 is incapable of producing a beam of light on the platform 106 for scanning a document. On the other hand, if size the scanning platform 106 is permitted to shrink, width of the scan document must be reduced. With a reduced platform dimension, the scanner no longer can scan an A4 size document.

FIG. 3 is a schematic side view of a conventional scanner with a book placed on the window ready for scanning. As shown in FIG. 3, the lamp 112 has a length greater than the width of the scanning platform 106. Due to size limitation at the opening section 104 and coverage of the casing 102 around the opening section 104, a scan document must be placed inside the window of the scanning platform 106 before scanning. However, width of the window is often too narrow for a non-planar document such as the bind pages of a book 150 or a large size document. Consequently, edges or binding area of the book 150 may not receive enough illumination from the light source to produce a quality image.

With so much limitations to consider, designing a scanning head with a smaller casing and a shorter lamp/reflective mirrors system inside the casing without affecting the scanning length and size of the scanning platform is one of the principle goals of this invention.

### SUMMARY OF INVENTION

Accordingly, one object of the present invention is to provide a scanner with a scanning head having a scattering light source and a scanning platform having a wide transparent window. The scattering light source is able to provide illumination to a scan line length greater than or equal to size of a document. Furthermore, width of the window on the scanning platform can be increased to accommodate the width of an A4 size document so that the scanner has a better competitive edge.

A second object of this invention is to provide a method of designing a scanning head. The design includes a smaller shell body and a lamp/reflective mirror system inside the shell body that has a shorter overall length so that material cost is lowered and the scanning head has a lighter weight.

A third object of this invention is to provide a shell body for a scanner that can provide sufficient illumination to the edges or binding area of the pages in a book so that overall scan quality is improved.

To achieve these and other advantages and in accordance with the purpose of the invention, as embodied and broadly described herein, the invention provides a scanner for scanning a document. The scanner mainly includes an outer casing, a platform, a scanning head, a linear guide and a driving device. The outer casing has an opening section with the platform positioned over the opening section. The scanning head mainly includes a shell body, a scattering light source, a plurality of reflecting mirrors, a lens and a photo-sensor. The scanning head is positioned inside the outer casing. Through the linear guide and the driving device, the scanning head moves in a scanning direction to capture image data from a document. The shell body of the scanning head has a long side having a length smaller than the length of the platform in a direction perpendicular to the scanning direction. In addition, the scattering light source mounts on the shell body to produce a parallel beam. The reflective mirrors, the lens and the photo-sensor are installed inside the shell body. After the parallel beam is projected onto the platform, the beam is reflected back and redirected to the reflecting mirrors and the lens sequentially before arriving at the photo-sensor.

This invention also provides a method of designing a scanning head for a scanner. The scanner has a platform and a scanning head. The scanning head travels in a scanning direction for scanning a document placed on the platform. The design method at least includes the following steps. First, a shell body with a long side whose length is smaller than the length of the platform in a direction perpendicular to the scanning direction is provided. Thereafter, a scattering light source is provided. The scattering light source mounts on the shell body to produce a parallel beam. The scattering light source has a length smaller than or equal to the length of the long side of the shell body. A plurality of reflecting mirrors, a lens and a photo-sensor are provided all installed inside the shell body. After the parallel beam is projected onto the platform, the beam is reflected back and redirected to the reflecting mirrors and the lens sequentially before arriving at the photo-sensor.

This invention also provides an outer casing and a platform for a scanner. The outer casing has an opening section. The lower edges around the opening section all include a supporting surface. The platform is positioned over the supporting surfaces. The platform has a surface area comparable to the area of the opening section.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a conventional scanner.

FIG. 2 is a schematic diagram showing the optical path design of a conventional scanning head.

FIG. 3 is a schematic side view of a conventional scanner with a book placed on the window ready for scanning.

FIG. 4 is a front view of a scanner according to one preferred embodiment of this invention.

FIG. 5 is a side view of the scanner as shown in FIG. 4.

FIG. 6 is a schematic diagram showing the optical path design according to the preferred embodiment of this invention.

FIG. 7 is a schematic side view of the scanner according to this invention with a book placed on the window ready for scanning.

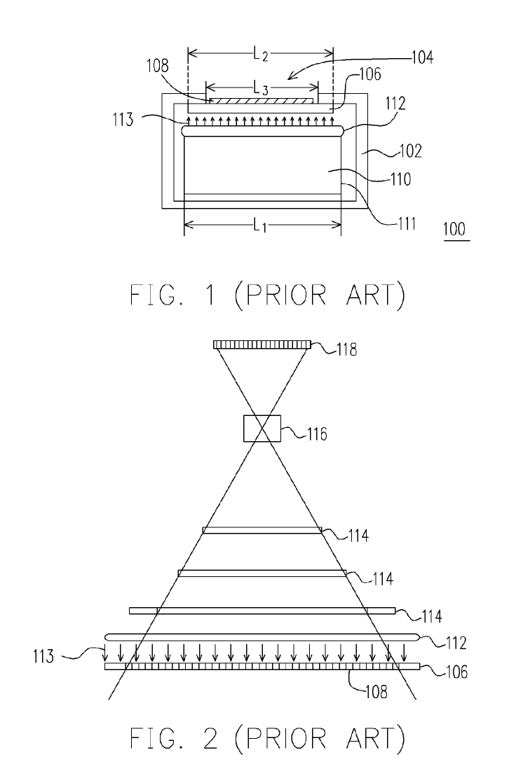

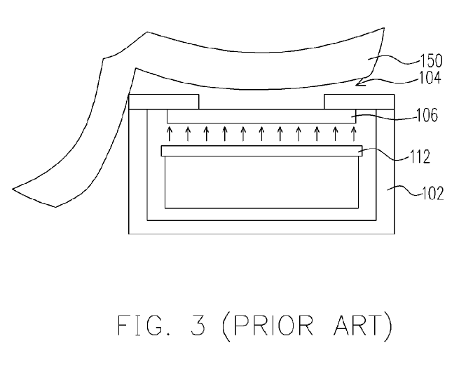

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

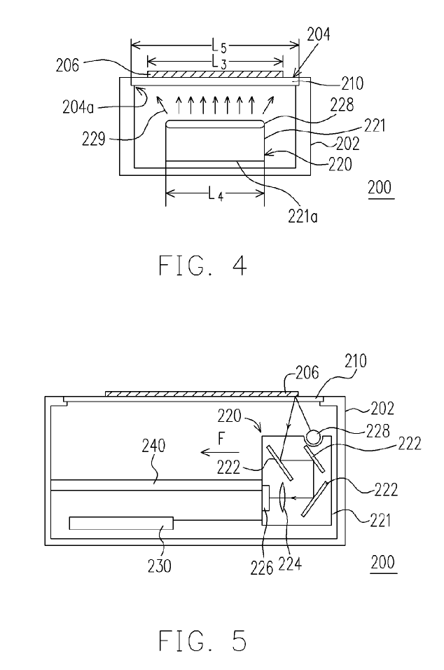

FIG. 4 is a front view of a scanner according to one preferred embodiment of this invention. FIG. 5 is a side view of the scanner as shown in FIG. 4. As shown in FIG. 4, the scanner 200 has an outer casing 202 with an opening section 204. The lower edges of opening section 204 have supporting surfaces 204a for supporting a platform 210. The platform 210 is, for example, a transparent glass platform or a transparent acrylic platform. The platform 210 and the supporting surfaces 204a are joined using double-sided tape, for example. With this arrangement, the platform 210 provides a large transparent window for scanning. The platform 210 can have a length L5 greater than the width of an A4 size paper and approach the width of a B4 size paper. Due to an increase in the width of the platform 210, a document 206 having a width greater than A4 size paper will not be blocked by the shell body 202. In other words, scanning length L3 of the document 206 can be increased.

As shown in FIG. 5, the interior of the scanner 200 further includes a scanning head 220, a driving device 230 and a linear guide 240. Guided by the linear guide 240 and driven by the driving device 230, the scanning head 220 is able to move forward in a scanning direction F to capture an image of the document 206. The driving device 230 is, for example, an electric motor/driving belt (not shown) system. The scanning head 220 is connected to the electric motor through the driving belt so that the motor can control the position and running speed of the scanning head 220. The linear guide is, for example, an axial rod with both ends fixed on the outer casing 202 and positioned in a direction parallel to the scanning direction F.

Note that the shell body and lamp in a conventional scanning heat is designed according to the size of the platform. In this invention, however, a scattering light source including a scattering lamp is set up on the shell body. As shown in FIGS. 4 and 5, the linear light 229 from the scattering light source 228 provides a scanning length L5 greater than or equal to the size of the platform 210. Hence, length L4 of the long side 221a of the shell body 221 and the scattering light source 228 need not correspond with the size of the platform 210. Rather, length L5 of the scanning line projected from the scattering light source 228 onto the platform 210 determines the length of the platform 210 that corresponds with the long side 221a of the shell body 221. This arrangement is simply opposite to the conventional design. Therefore, the scanner 200 can be miniaturized and trimmed to reduce material cost. Nevertheless, width of the scan document 206 or size of the platform 210 is unaffected by the reduction of scanning head 220. In other words, the scanner can still scan documents having a width greater than an A4 size paper and hence maintain a competitive edge in the market.

FIG. 6 is a schematic diagram showing the optical path design according to the preferred embodiment of this invention. As shown in FIG. 6, the scanning head 220 further includes a plurality of reflecting mirrors 222, a lens 224 and a photo-sensor 226. The optical path inside the scanning head 220 begins at the scattering light source 228. Light from the scattering light source 228 projects a parallel beam 229 onto the platform 210 to produce a scan line such that the scan line length L6 is defined as the largest scanning width of the document 206 and the best width for the window on the platform 210. A set of reflecting mirrors 222 each with a different length is sequentially set up along the optical path above the document 206. The lens 224 and the photo-sensor 226 are positioned after the set of reflecting mirrors 222. Thus, the linear light 229 projecting from the scattering light source 228 onto the platform 210 will reflect from the surface of the document 206 and then sequentially pass through the first, the second, the third reflecting mirrors 222 to form a light cone that converges onto the lens 224. Thereafter, image of the document 206 is projected out from the other end of the lens 224 in the form of a light cone to the photo-sensor 226.

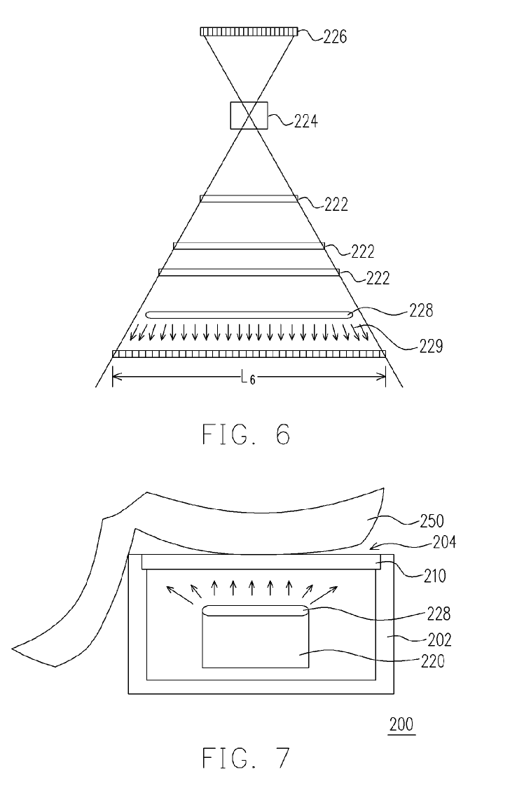

FIG. 7 is a schematic side view of the scanner according to this invention with a book placed on the window ready for scanning. As shown in FIG. 7, putting a book 250 flat on the platform 210 is difficult. Furthermore, to prevent the outer casing 202 around the opening section 204 from blocking the edges or binding of the book 250, width of the platform 210 is purposely made closer to the side of the outer casing 202. Hence, the platform 210 has an area almost identical to the area of the opening section 204 in the outer casing 202. Accordingly, light projecting to the platform 210 will not be limited by size of the opening section 204 so that the edges or binding area of the book 250 will receive sufficient illumination to improve the scanning quality. In addition, surface area of the platform 210 can be optimally utilized.

In summary, the scanner and the scanning head design according to this invention includes at least the following advantages: 1. A scattering lamp is used as the light source to produce a parallel beam. Consequently, length of the lamp and width of the reflecting mirrors can be reduced. That means, the shell body housing the lamp and the mirrors can also be reduced. With a smaller and lighter scanning head, overall material cost is reduced. 2. A scanning head with a scattering lamp therein is used to optimize the design of the platform. Yet, size of the window on the platform is totally unaffected by the miniaturization of the scanning head. In other words, the scanner is still capable of scanning a document with a width greater than an A4 size paper. Therefore, the new design can maintain a competitive edge among conventional scanners. 3. Width of the platform may approach the long edge of the outer casing so that the platform has an area almost identical to the area of the opening section. Thus, the platform area is optimally utilized.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method of designing a scanning head for a scanner, wherein the scanner has a platform and a scanning head with the scanning head capable of moving along a scanning direction to scan a document placed on the platform, the method at least including:
providing a shell body of the scanning head having a long side, wherein a length of the long side is smaller than a length of the platform along a direction perpendicular to the scanning direction;
providing a scattering light source mounted on the long side of the shell body for producing a parallel beam of light, wherein a length of the scattering light source is smaller than or equal to the length of the long side of the shell body;
providing a plurality of reflecting mirrors within the shell body;
providing a lens within the shell body; and
providing a photo-sensor within the shell body, wherein the parallel beam from the light source projecting onto the platform will sequentially pass through the reflecting mirrors and the lens to arrive at the photo-sensor after reflection.

2. The method of claim 1, wherein the reflecting mirrors have a length smaller than or equal to length of the scattering light source.

3. The method of claim 1, wherein a length of the parallel light beam projecting onto the platform is larger than or equal to the length of the platform in a direction perpendicular to the scanning direction.

4. The design method of claim 1, wherein the scattering light source includes a scattering lamp tube.

5. A method of designing an optical path for a scanner, wherein the scanner has a platform and a scanning head, and the scanning head is capable of moving in a scanning direction to scan a document placed on the platform, the method including:
providing a scattering light source mounted on the scanning head;
projecting a parallel beam from the scattering light source onto the platform to produce a scan line;
defining a length of the scan line as a maximum width of scanning on the document;
providing a plurality of reflecting mirrors sequentially positioned along an optical path beyond the document;
providing a lens positioned along an optical path beyond the set of reflecting mirrors; and
providing a photo-sensor along an optical path beyond the lens, wherein the parallel beam from the light source projecting onto the platform sequentially passes through the reflecting mirrors and the lens to arrive at the photo-sensor after reflection.

6. The design method of claim 5, wherein the scattering light source includes a scattering lamp tube.

7. The design method of claim 5, wherein the reflecting mirrors has a length smaller than or equal to the length of the scattering light source.

8. The design method of claim 5, wherein a length of the scan line is an optimal width of the window on the platform.

9. An outer casing and a platform for a scanner, at least comprising:
an outer casing having an opening section, wherein lower edges of the opening section have supporting surfaces; and
a platform on the supporting surfaces, wherein an area of the platform is identical to an area of the opening section.

10. A scanning head for a scanner, wherein the scanner has a platform for putting a document, and the scanning head is capable of moving forward in a scanning direction to scan the document, the scanning head at least comprises:
a shell body with a long side, wherein a length of the long side is smaller than a length of the platform in a direction perpendicular to the scanning direction;
a scattering light source mounted on the long side of the shell body for producing a parallel beam of light, wherein the scattering light source has a length smaller than or equal to the length of the long side of the shell body;
a plurality of reflecting mirrors within the shell body;
a lens within the shell body; and
a photo-sensor within the shell body, wherein the parallel beam from the light source projecting onto the platform sequentially passes through the reflecting mirrors and the lens to arrive at the photo-sensor after reflection.

11. The scanning head of claim 10, wherein the scattering light source includes a scattering lamp tube.

12. The scanning head of claim 10, wherein the reflecting mirrors has a length smaller than or equal to the length of the scattering light source.

13. A scanner for scanning a document, at least comprising:
an outer casing with an opening section;
a platform over the opening section for putting the document;
a scanning head within the outer casing, wherein the scanning head is capable of moving forward in a scanning direction to scan the document, wherein the scanning head further includes:
a shell body with a long side, wherein a length of the long side is smaller than a length of the platform in a direction perpendicular to the scanning direction;
a scattering light source mounted on the long side of the shell body for producing a parallel beam of light, wherein the scattering light source has a length smaller than or equal to the length of the long side of the shell body;
a plurality of reflecting mirrors within the shell body;
a lens within the shell body; and
a photo-sensor within the shell body, wherein the parallel beam from the light source projecting onto the platform sequentially passes through the reflecting mirrors and the lens to arrive at the photo-sensor after reflection;
a linear guide within the outer casing for guiding the scanning head; and
a driving device within the outer casing for driving the scanning head.

14. The scanner of claim 13, wherein the scattering light source includes a scattering lamp tube.
